(19) United States
(12) Patent Application Publication
(10) Pub. No.: US 2016/0292299 A1
(43) Pub. Date: Oct. 6, 2016

(54) DETERMINING AND INFERRING USER ATTRIBUTES

(71) Applicant: Google Inc., Mountain View, CA (US)

(72) Inventors: Shobha Diwakar, Mountain View, CA (US); Pranav Khaitan, Mountain View, CA (US)

(73) Assignee: Google Inc., Mountain View, CA (US)

(21) Appl. No.: 14/167,589

(22) Filed: Jan. 29, 2014

(51) Int. Cl. G06F 17/30

(52) U.S. Cl. CPC G06F 17/30958

(57) ABSTRACT

Methods and apparatus for determining and inferring user attributes based on detected user activity are presented. A first user attribute may be determined based on first activity of a user. A second user attribute related to the first user attribute may be inferred. A third user attribute may be determined based on second activity of the user that occurs after the first activity. A confidence associated with the second user attribute may be altered in response to a determination that the third user attribute is related to the second user attribute.

### BACKGROUND

Search engines provide information about documents such as web pages, images, text documents, emails, and/or multimedia content that is hosted remotely from a particular computing device. A search engine may identify the documents in response to a user's search query that includes one or more search terms. The search engine may rank the documents based on the relevance of the documents to the query and the importance of the documents, and may provide search results that include aspects of and/or links to the identified documents. In some cases, search engines may additionally or alternatively provide information that is responsive to the search query yet unrelated to any particular document (e.g., “local time in Tokyo”).

Various applications facilitate additional user interaction with documents and information that is hosted remotely from a particular computing device. Media applications enable users to download and/or stream music and/or videos to various computing devices such as smart phones or tablet computers. Map applications enable users to use GPS to navigate, find locations and/or search for recommendations of suitable destinations such as restaurants, museums, etc. Online calendars, sometimes associated with email programs, may keep track of a user's schedule. Each of these applications may utilize separate records of past user activity to attempt to rank, recommend or otherwise present content to a user.

### SUMMARY

This specification is directed generally to methods and apparatus for building and maintaining, for an individual user, a collection of detected and inferred attributes of that user (e.g., interests, preferences, tastes, patterns of behavior, characteristics, etc.), as well as relationships between those user attributes. In some implementations, the collection may be represented as a graph, with nodes representing user attributes and edges representing relationships between those attributes. Some user attributes may be determined based on detected user activity. For instance, a search engine query may reveal that a user is interested in a particular activity. Other “potential” user attributes may be inferred based on user attributes determined from detected user activity, as well as based on other preexisting data (e.g., aggregate user interests). User attributes may have associated “confidences,” or weights, that represent, for instance, how likely it is that an inferred attribute truly can be associated with a user. These confidences may be altered in response to various events. For example, after a particular user attribute is determined from initial user activity, if subsequent user activity supports, or “corroborates” that particular user attribute (e.g., affirms that the user attribute is truly attributable to the user), the confidence associated with that user attribute may increase. Additionally, confidences associated with related user attributes that were inferred based on the particular user attribute may also increase. Collections of user attributes, which in some instances may be represented as user attribute graphs, may be used for various purposes, such as clustering similar users, generating alternative query suggestions to users, ranking search results for users, making recommendations to users, and so forth.

In some implementations, a computer implemented method may be provided that includes the steps of: determining, by a computer system based on first activity of a user, a first user attribute; inferring, by the computer system, a second user attribute related to the first user attribute; determining, by the computer system based on second activity of the user that occurs after the first activity, a third user attribute; and altering, by the computer system, a confidence associated with the second user attribute in response to a determination that the third user attribute is related to the second user attribute.

This method and other implementations of technology disclosed herein may each optionally include one or more of the following features.

In various implementations, the method may further comprise adding nodes and edges to a user attribute graph associated with the user, wherein the nodes represent the first, second and third user attributes, and the edges represent relationships between the first, second and third user attributes. In various implementations, altering the confidence associated with the second user attribute comprises storing, in association with a node representing the second user attribute, a confidence value.

In various implementations, the inferring comprises inferring the second user attribute related to the first user attribute based on data that preexists the first user activity. In various implementations, the preexisting data comprises aggregate user attributes of a population of users with which the user is associated. In various implementations, the preexisting data comprises an aggregate user attribute graph associated with a population of users with which the user is associated.

In various implementations, the method further includes altering, by the computer system, a confidence associated with the first user attribute based on one or more additional activities by the user that corroborate the first user attribute. In various implementations, the method further includes altering, by the computer system, the confidence associated with the second user attribute based on the alteration of the confidence associated with the first user attribute. In various implementations, the method further includes classifying, by the computer system, the first user attribute as long-term in response to the confidence associated with the first user attribute satisfying a confidence threshold over a predetermined time interval.

In various implementations, the method further includes classifying, by the computer system, a user attribute as short-term or long term based on corroboration of the user attribute over time. In various implementations, the method further includes reclassifying, by the computer system, a short-term user attribute as long term in response to a confidence associated with the short-term user attribute satisfying a confidence threshold over a predetermined time interval. In various implementations, the method further includes decaying, by the computer system, a confidence associated with a long-term user attribute between instances in which the long-term user attribute is corroborated. In various implementations, the method further includes declassifying the long-term user attribute in response to a determination that the confidence associated with the long-term user attribute no longer satisfies a threshold.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which user attributes may be determined and inferred based on user activity.

FIG. 2 is a flow chart illustrating an example method of building and maintaining collections of user attributes.

FIGS. 3A-C depict a conceptual example of how a collection of user attributes may be built and grown based on user activity, in accordance with various implementations.

FIG. 4 illustrates an example architecture of a computer system.

### DETAILED DESCRIPTION

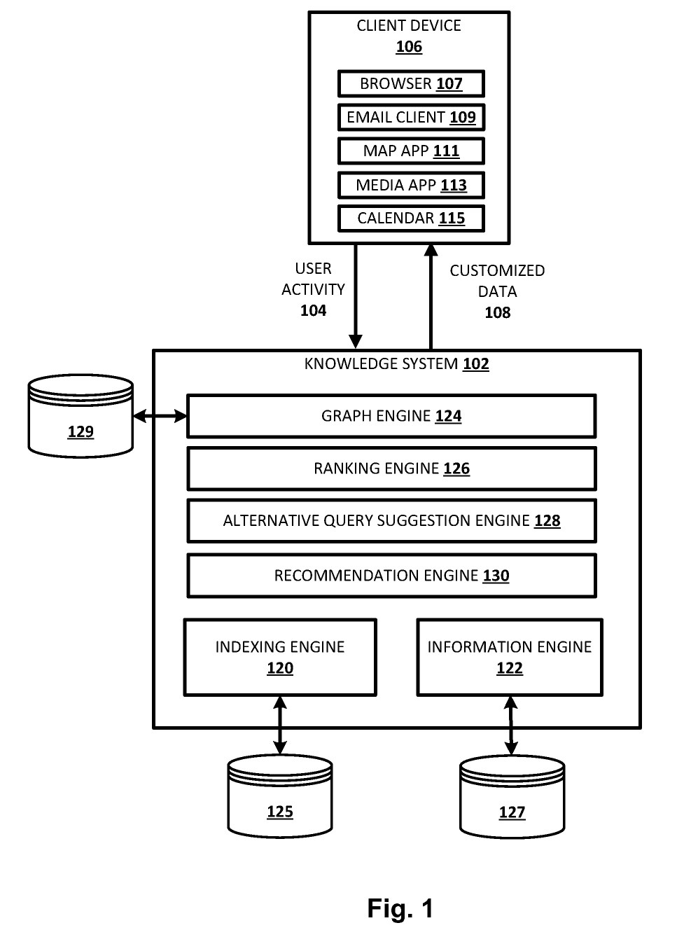

FIG. 1 illustrates an example environment in which a collection of attributes of a particular user may be built, grown and/or maintained based on detected user activity. The example environment includes a client device 106 and a knowledge system 102. Knowledge system 102 may be implemented in one or more computers that communicate, for example, through a network (not depicted). Knowledge system 102 is an example of an information retrieval system in which the systems, components, and techniques described herein may be implemented and/or with which systems, components, and techniques described herein may interface.

A user may interact with knowledge system 102 via client device 106 and/or other computing systems (not shown). Knowledge system 102 may detect activity of the particular user, such as activity 104 by that user on client device 106 or activity by that user on other computing devices (not shown), and provide various customized data 108 to client device 106 or to other computing devices used by the user (again, not shown). While the user likely will operate a plurality of computing devices, for the sake of brevity, examples described in this disclosure will focus on the user operating client device 106.

User activity 104 may include information indicative of one or more actions taken by the user using client device 106 (or another computing device). User activity 104 may include activity performed by the user across a plurality of applications. For example, the client device 106 may execute one or more applications, such as a browser 107, email client 109, map application 111, media application 113, and/or calendar application 115. In some instances, one or more of these applications may be operated on multiple client devices operated by the user. Additionally, user activity may include but is not limited to a user's search history, click through rates, contents of email/text/social network messages to/from other users, the user's schedule in a calendar, the user's purchase history, games played by the user, locations visited by the user (e.g., as tracked by a map application), media consumed (and reconsumed) by the user, and so forth. Customized data 108 may include a wide variety of data and information, including but not limited to search results ranked in accordance with the user's attributes, one or more alternative query suggestions or navigational search results tailored to the user's attributes, advertising targeted towards the user, recommendations for items (e.g., songs, videos, restaurants, etc.) to consume, and so forth.

Client device 106 may be a computer coupled to the knowledge system 102 through a network such as a local area network (LAN) or wide area network (WAN) such as the Internet. The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. As noted above, client device may execute one or more of applications 107, 109, 111, 113 and 114. One or more user actions performed with these applications, or that are related to these applications, may be detected by knowledge system 102.

The client device 106 and the knowledge system 102 each include memory for storage of data and software applications, a processor for accessing data and executing applications, and components that facilitate communication over a network. The operations performed by the client device 106 and/or the knowledge system 102 may be distributed across multiple computer systems. The knowledge system 102 may be implemented as, for example, computer programs running on one or more computers in one or more locations that are coupled to each other through a network.

In various implementations, knowledge system 102 may include an indexing engine 120, an information engine 122, a graph engine 124, a ranking engine 126, an alternative query suggestion engine 128, and a recommendation engine 130. In some implementations one or more of engines 120, 124, 126, 128 and/or 130 may be omitted. In some implementations all or aspects of one or more of engines 120, 124, 126, 128 and/or 130 may be combined. In some implementations, one or more of engines 120, 124, 126, 128 and/or 130 may be implemented in a component that is separate from the knowledge system 102. In some implementations, one or more of engines 124, 126, 128 and/or 130, or any operative portion thereof, may be implemented in a component that is executed by client device 106.

Indexing engine 120 may maintain an index 125 for use by knowledge system 102. Indexing engine 120 may process documents and updates index entries in the index 125, for example, using conventional and/or other indexing techniques. For example, indexing engine 120 may crawl one or more resources such as the World Wide Web and index documents accessed via such crawling. As another example, indexing engine 120 may receive information related to one or documents from one or more resources such as web masters controlling such documents and index the documents based on such information. A document is any data that is associated with a document address. Documents include web pages, word processing documents, portable document format (PDF) documents, images, emails, calendar entries, videos, and web feeds, to name just a few. Each document may include content such as, for example: text, images, videos, sounds, embedded information (e.g., meta information and/or hyperlinks); and/or embedded instructions (e.g., ECMAScript implementations such as JavaScript).

Information engine 122 may optionally maintain another index 127 that includes or facilitates access to non-document-specific information for use by the knowledge system 102. For example, knowledge system 102 may be configured to return information in response to search queries that appear to seek specific information. If a user searches for “Ronald Reagan's birthday,” knowledge system 102 may receive, e.g., from information engine 122, the date, “Feb. 6, 1911.” In some implementations, index 127 itself may contain information, or it may link to one or more other sources of information, such as online encyclopedias, almanacs, and so forth. In various implementations, index 125 or index 127 may include mappings between queries (or query terms) and documents and/or information. In some implementations, index 127 may include a knowledge graph that includes nodes that represent various entities and weighted edges that represent relationships between those entities. Such a knowledge graph may be built, for instance, by crawling a plurality of databases, online encyclopedias, and so forth, to accumulate nodes presenting entities and edges representing relationships between those entities.

In this specification, the term “database” and “index” will be used broadly to refer to any collection of data. The data of the database and/or the index does not need to be structured in any particular way and it can be stored on storage devices in one or more geographic locations. Thus, for example, the indices 125 and 127 may include multiple collections of data, each of which may be organized and accessed differently.

Graph engine 124 may build and maintain an index 129 of collections of attributes associated with individual users as well as one or more collections of aggregate user attributes associated with one or more populations of users. In various implementations, graph engine 124 may represent user attributes as nodes and relationships between user attributes as edges. In various implementations, graph engine 124 may represent collections of user attributes as directed or undirected graphs, hierarchal graphs (e.g., trees), and so forth. As will be described below, graph engine 124 may utilize aggregate user attribute information from index 129 to infer one or more potential user attributes of a particular user based on activity by that user.

In various implementations, aggregate user attribute collections contained in index 129 may be altered based on detected individual user activity and/or on user-specific user attribute collections developed over time, and vice versa. For example, user attributes not previously known to be related may have their respective nodes in an aggregate user attribute graph connected by an edge when it is detected that most users exhibiting one of the attributes also exhibit the other. As another example, assume that user attribute graphs associated with individual users reveal collectively that two attributes are more closely related than previously thought. Corresponding aggregate user attributes in index 129 may be altered to reflect that closer-than-previously-thought relationship, e.g., by adding an edge directly between nodes representing the two aggregate user attributes where previously there was only an indirect connection.

Ranking engine 126 may use the indices 125 and/or 127 to identify documents and other information responsive to a search query, for example, using conventional and/or other information retrieval techniques. The ranking engine 126 may calculate scores for the documents and other information identified as responsive to a search query, for example, using one or more ranking signals. Each ranking signal may provide information about the document or information itself, the relationship between the document or information and the search query, and/or the relationship between the document or information and the user performing the search. In some implementations, ranking engine 126 may also use information provided by graph engine 124, such as aggregate user attribute information or user attribute information associated with a specific user, to identify/rank documents and other information responsive to a search query and/or to calculate scores for documents and other information.

Alternative query suggestion engine 128 may use one or more signals and/or other information, such as a database of alternative query suggestions (not depicted), contextual cues related to a user of client device 106 (e.g., GPS location, other sensor readings), or user attribute information provided by graph engine 124, to generate alternative query suggestions to provide to client device 106. As a user types consecutive characters of the search query, alternative query suggestion engine 128 may identify alternative queries that may be likely to yield results that are useful to the user. For instance, assume the client device 106 is located in Chicago, and has typed the characters, “restaur.” Alternative query suggestion engine 128 may, based on a signal indicating that client device 106 is in Chicago and a user attribute “interest in live music” provided by graph engine 124, suggest a query, “restaurants in Chicago with live music.”

In various implementations, recommendation engine 130 may use indices 125 and 127, as well as user attribute information provided by graph engine 124, to select one or more consumables (e.g., songs, videos, restaurants, articles, etc.) to recommend to the user for consumption. For example, if graph engine 124 indicates that an attribute of a user is an interest in skiing, videos related to skiing may be recommended to the user, e.g., by media application 113, after the user finishes consuming another video.

Using components such as those depicted in FIG. 1, a user's activity may be detected, and user attributes may be determined and inferred from that detected activity. For example, if a user performs one search engine search for “2013 top selling fiction books” and another for “best classics,” knowledge system 102 may determine one attribute of the user to be a preference for “fiction books” and another attribute of the user to be a preference for classics. Knowledge system 102 may also infer, based on both searches and/or preexisting data (e.g., from index 129), another attribute of the user to be “reader.” If the user later performs activity that corroborates an interest in reading, a confidence associated with the inferred user attribute “reader” may be increased. However, if it turns out the user doesn't like reading and was merely shopping for gifts to give a bibliophile friend, that user's later activity may not further corroborate the user attribute “reader.”

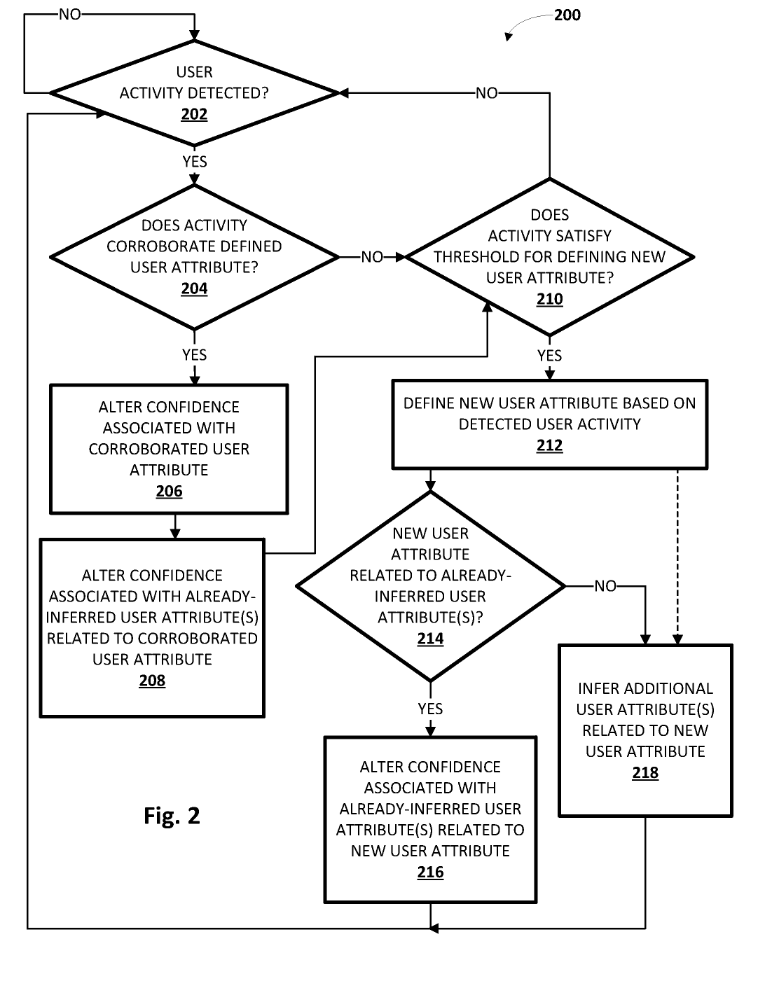

Referring now to FIG. 2, an example method 200 of building and maintaining a collection of attributes of a user is depicted. For convenience, the operations of the flow chart are described with reference to a system that performs the operations. This system may include various components of various computer systems. For instance, some operations may be performed at the client device 106, while other operations may be performed by one or more components of the knowledge system 102, such as recommendation engine 130, alternative query suggestion engine 128, graph engine 124, and so forth. Moreover, while operations of method 200 are shown in a particular order, this is not meant to be limiting. One or more operations may be reordered, omitted or added.

At block 202, the system may detect user activity. For instance, the user may submit a query to a search engine, may use a social networking application to “check in” to a particular restaurant, may create a new calendar entry, and so forth. The system may detect this activity by, for instance, analyzing search histories or check-in histories, detecting changes in a user's calendar, and so forth. At block 204, the system may determine whether the detected activity corroborates an already-defined user attribute. For instance, if the user previously demonstrated an interest in “Italian cooking,” then new user activity that relates to Italian cooking, such as making a reservation at an Italian restaurant or downloading a recipe for Italian food, may be considered to have corroborated the user's interest in Italian cooking.

If the answer at block 204 is yes, then method 200 may proceed to block 206. At block 206, the system may alter a confidence associated with the corroborated user attribute. For instance, the system may increase a value of a confidence associated with this user attribute. At block 208, the system may “propagate” the user's interest to related but inferred user attributes. For instance, the system may alter (e.g., increase) a confidence associated with one or more already-inferred user attributes that are related to (e.g., parent node of) the user attribute under consideration. Method 200 may then proceed to block 210.

Back at block 204, if it is determined that the detected user activity does not corroborate any previously defined user attribute, then method 200 may proceed to block 210. Thus, in this particular implementation, method 200 may always proceed through block 210. However, this is not required, and in other implementations, other paths may be taken that do not pass through block 210.

At block 210, it may be determined whether the user activity detected at block 202 satisfies a threshold for defining a new user attribute. In some implementations, a single mention of a particular concept in a search query may not be considered sufficient to define an attribute of a user. For instance, assume a user submits a search query that includes the word “bridge.” “Bridge” may have several different meanings in various contexts. For instance, in the architectural context, it may refer to a structure used to cross a waterway or other obstacle. In the computing context, it may refer to a device that facilitates communication between other devices. “Bridge” may have other meanings in, for instance, the dental context. At any rate, the system may determine that use of such an ambiguous term does not warrant user attribute creation. In contrast, “bridge” in combination with other words that clarify the context, such as “computer network components,” may lend sufficient clarity to the user's activity to warrant definition of a new user attribute of “interest in networking technologies.” Or, if not enough additional words are present to determine a context of the word “bridge,” the system may consult information engine 122, which may search a knowledge graph stored in index 127 to see which potential user attributes are most likely to be associated with the word “bridge.”

If the answer at block 210 is no, then method 200 may proceed back to block 202. However, if the answer at block 210 is yes, then the system may define a new user attribute at block 212. In some implementations, defining a new user attribute may include adding a node to an existing user attribute graph. In various implementations, the new user attribute may be assigned various levels of confidence depending on various things, such as how strongly the detected user activity suggests the determined user attribute, settings of the system, and so forth.

At block 214, the system may determine whether the newly-defined attribute is related to any already-inferred attributes. For instance, the system may start at a node created to represent the user attribute newly defined at block 212, and may traverse one or more edges of the user attribute graph to other related nodes. In some implementations, the number of edges that the system will traverse may depend on various factors, such as user settings, strength of confidence associated with the newly-created node, strength of confidence associated with a traversed-to node, and so forth. If the answer at block 214 is yes, then at block 216, the system may alter (e.g., increase) confidence(s) associated with related node(s). Method 200 may then return to block 202. However, if the answer at block 214 is no, then method 200 may proceed to block 218.

At block 218, the system may infer one or more new user attributes based at least in part on the new user attribute defined at block 212. In various implementations, the system may base this inference off of an aggregate user attribute graph from index 129. As mentioned previously, this aggregate user attribute graph may include nodes representing attributes of a plurality of users and edges representing relationships between the nodes. The nodes of the aggregate user attribute graph may exist even prior to a particular user, component and/or computing system causing performance of method 200 to build an attribute graph tailored to the user. In some implementations, user attributes inferred at block 218 may be assigned less confidence initially than user attributes define at block 212 based on detected user activity.

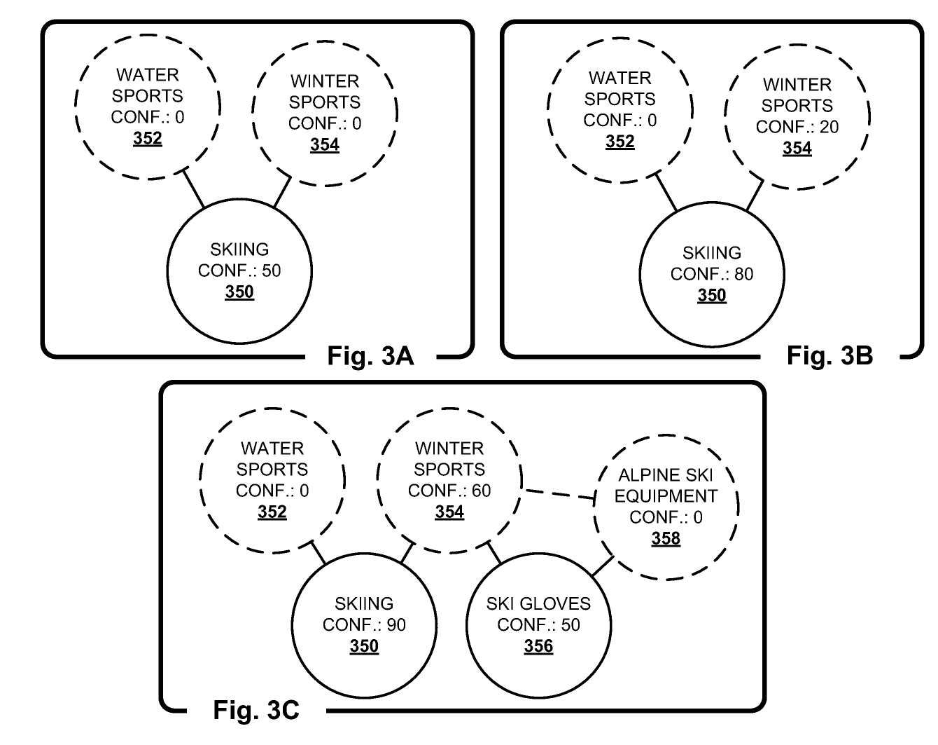

FIGS. 3A-C depict conceptually an example of how a collection of user attributes may be built and grown based on user activity. Nodes represent user attributes both determined directly from user activity (solid lines) and inferred (dashed lines). Edges between nodes represent relationships between those use attributes. In FIG. 3A, assume that user activity reveals that one attribute of the user is an interest in “skiing.” Perhaps the user submitted a query to a search engine that included the word “skiing,” or added an entry to her calendar (e.g., using calendar application 115) that included the word “skiing.” A first node 350 has been defined to represent the user attribute of interest in skiing. Two additional nodes, 352 (“water sports”) and 354 (“winter sports”), have been inferred based on the user's interest in skiing and on preexisting data. For example, an aggregate user attribute graph in index 129 may reveal that generally, users interested in “skiing” may be also interested in water sports or winter sports. Or, a knowledge graph in index 127 may reveal that in general, “skiing” is related to both winter sports and water sports.

Node 350 has been assigned a confidence of fifty because the represented user attribute, interest in skiing, was directly detected, rather than inferred. In contrast, the other two nodes, 352 and 354, are assigned confidences of zero because they are inferred from user activity and preexisting data, not defined based directly on detected user activity. In various implementations, various confidences may be assigned to newly-defined user attribute nodes based on various things, such as user preferences, detected user activity that lead to creation of the user attribute node, and so forth. For example, user activity may be analyzed to determine how strong a user interest in a particular concept appears to be. In some implementations, the user activity may be analyzed in combination with other contextual cues, such as the time of year, upcoming weather, the user's location, and so forth. It should be noted that the confidence values described herein, which generally are positive integers between zero and one hundred, are arbitrarily selected for illustrative purposes only, and are not meant to be limiting in any way. Other measurements of confidence may be used instead, such as values between zero and one, between zero/one and ten, and so forth.

In FIG. 3B, assume that user activity that occurred subsequent to that described above with reference to FIG. 3A provides additional evidence of the user's interest in “skiing,” in effect corroborating the user attribute already defined by node 350. For instance, assume the user sends an invitation to a friend over a social network, asking, “Do you want to go snow skiing on Sunday?” Such activity may cause the confidence associated with node 350 to increase, e.g., from fifty to eighty (again, these values selected arbitrarily for illustrative purposes only).

Additionally, in FIG. 3B, the confidence increase at node 350 has propagated to node 354 (“winter sports”). This may be due to the subsequent user activity and/or other contextual cues suggesting a relationship between the “skiing” in the user's invitation and the user attribute of interest in winter sports. For example, the user's message explicitly referred to “snow” in combination with “skiing,” which may increase confidence associated with the “winter sports” user attribute node 354, but not necessarily confidence associated with “water sports” user attribute node 352. Even if the message were less explicit, for instance omitting the word “snow,” other contextual cues such as the user's calendar may reveal that on Sunday, the user will be in a particular region or at a particular location at which the weather will be cold, thus suggesting that the “skiing” referred to in the user's social network invitation refers to snow skiing, as opposed to water skiing. Either way, because this increase in confidence in “winter sport” user attribute node 354 is based primarily on circumstantial evidence (i.e. evidence that suggests, but does not directly demonstrate), rather than direct evidence (i.e., evidence that directly demonstrates), the increase in confidence (e.g., +20) may be less than an increase in confidence at node 350, wherein the corroborating evidence was more direct than circumstantial.

In FIG. 3C, assume that user activity that was detected after the activity described above with reference to FIGS. 3A and 3B evidences a user attribute of interest in ski gloves. For instance, assume the user performs a search engine search for “alpine ski gloves.” This may cause a new node 356 to be created representing a user attribute of interest in ski gloves. While, like node 350 upon its creation, new node 356 has once again been assigned a confidence of fifty, this is not meant to be limiting. The subsequent user activity or contextual cues may call for a different confidence to be assigned to the newly created node 356.

In this example, ski gloves are determined to be related to winter sports, thus causing another increase in confidence at the “winter sports” user attribute node 354. In some implementations, such increases in confidence may grow larger over time as more user activity corroborates those user attributes. For instance, in FIG. 3C, “winter sports” user attribute node 354 has increased in confidence by forty, rather than by twenty like it did in FIG. 3B. In some implementations, such an increase in confidence at an inferred user attribute node may further propagate down to child user attribute nodes that are determined to be related to one or both of the inferred node and the newly added node. For instance, in FIG. 3C, the increase in confidence at “winter sports” user attribute node 354 has propagated down to “skiing” user attribute node 350 (e.g., increased from eighty to ninety). This may be due to an aggregate user attribute graph in index 129 and/or a knowledge graph in index 127 revealing that “ski gloves” are also related to “skiing.” By contrast, had the user searched for “snowboarding gloves” instead of “alpine skiing gloves,” “winter sports” user attribute node 354 may still have had its confidence increase, but that confidence may not have propagated down to “skiing” user attribute node 350.

Additionally in FIG. 3C, an “alpine ski equipment” user attribute node 358 has been inferred based on the newly created “ski gloves” user attribute node 356. A dashed edge is shown between “alpine ski equipment” user attribute node 358 and “winter sports” user attribute node 354 to represent that in some implementations, if a newly inferred node turns out to be related to an already-inferred node, a confidence associated with the already-inferred node may be increased accordingly and an edge may be added therebetween. Moreover, user attribute nodes 352 and 354 were, out of necessity because no user attribute graph existed previously, inferred based on data that preexisted the user attribute graph. However, any further inferred nodes, such as “alpine ski equipment” user attribute node 358, may be inferred based additionally on nodes already added to the user attribute graph. For instance, “alpine ski equipment” user attribute note 358 may be more likely to be inferred because the user has already increased confidence associated with “winter sports” user attribute node 354.

In an additional aspect, a user attribute graph may have a notion of time. Based on corroboration (or lack thereof) over time, user attributes may experience increases or decreases in confidence, which in turn may lead to their being classified as short-term or long-term. These classifications may dictate how and when the user attributes are used to, for instance, cluster similar users together (e.g., for marketing campaigns), provide alternative query suggestions (e.g., for presentation at browser 107), rank search results (e.g., for presentation at browser 107), select targeted advertising (e.g., to send to browser 107), recommend items for consumption (e.g., for presentation at map application 111 or media application 113), and so forth. User attributes may be classified short-term in response to user activity over a relatively short time interval that suggests an immediate interest (e.g., an upcoming ski trip). User attributes may be designated long-term in response to a confidence associated with a short-term user attribute node increasing over a longer time interval such that it satisfies a confidence threshold.

For instance, activity by a user occurring over a relatively short period of time that includes searches relating to alpine ski gear, an imminent ski trip scheduled in the user's calendar, and snow-skiing-related messages exchanged recently by the user with others, may cause attributes of that user that are associated with winter sports to experience increases in confidence in the short term. This may lead to one or more of those user attributes being classified short-term. When subsequent activity by the user relates to winter sports, these short-term nodes may be favored over long-term nodes when suggesting alternative queries, ranking search results, selecting targeted advertising, suggesting items for consumption, etc.

In some implementations, if related user attributes' confidences grow over a predetermined time interval, e.g., such that confidences associated with those user attributes satisfy one or more confidence thresholds, those user attributes may be “promoted” (i.e., reclassified) from short-term to long-term. Long-term user attributes may be favored over short term attributes, e.g., when clustering similar users, suggesting alternative query suggestions, ranking search results, selecting targeted advertising, recommending items for consumption, etc., where the user's immediate activity appears generic, or at least unrelated to one or more short term nodes.

In some implementations, a confidence associated with a long-term user attribute may be decayed between instances of corroboration. For instance, a long-term user attribute of “Specialist” may be corroborated far less after the user is promoted to a new rank. As time passes between corroborations of the user attribute “Specialist,” a confidence associated with that user attribute may decay. Eventually, the long-term user attribute may be declassified from long-term in response to a determination that its associated confidence no longer satisfies a threshold. In some implementations, decay of confidence associated with a user attribute may be accelerated where another user attribute considered an “alternative” to the first user attribute begins to be corroborated more often. For instance, if the user with the long-term user attribute of “Specialist” is promoted to “Sergeant,” that user's subsequent user activity may cause a new user attribute of “Sergeant” to be defined for the user. Because “Sergeant” is an alternative rank to “Specialist,” confidence of the user attribute of “Specialist” may be decayed more rapidly. In some implementations, if a confidence associated with a particular user attribute decays too far, a node representing that user attribute may be dropped from the user attribute collection altogether.

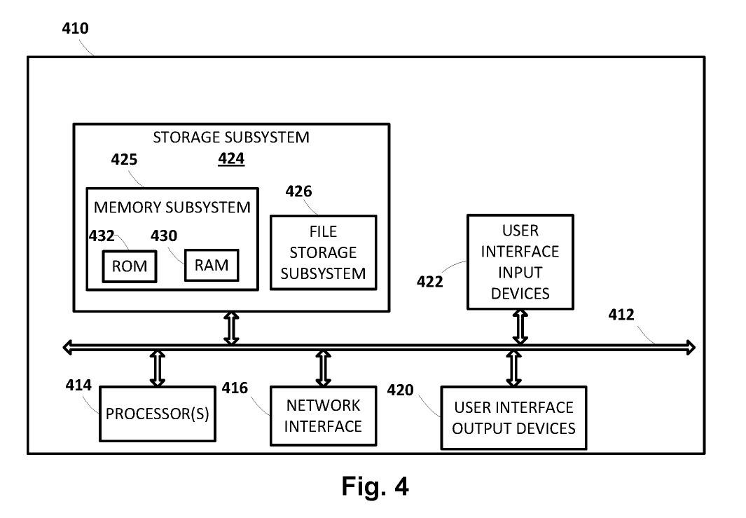

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 200, as well as one or more of the operations performed by indexing engine 120, information engine 122, graph engine 124, ranking engine 126, alternative query suggestion engine 128, recommendation engine 130, and so forth.

These software modules are generally executed by processor 414 alone or in combination with other processors. Memory 425 used in the storage subsystem can include a number of memories including a main random access memory (RAM) 430 for storage of instructions and data during program execution and a read only memory (ROM) 432 in which fixed instructions are stored. A file storage subsystem 424 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 424 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method, comprising:
determining, by a computer system based on activity of a user, a plurality of user attributes associated with the user, wherein one or more of the plurality of user attributes are inferred from other user attributes of the plurality of user attributes;
classifying, by the computer system, one or more of the plurality of user attributes as short-term or long term based on corroboration of the respective user attribute over time;
receiving, by the computer system after the classifying, a search query submitted from the user using a remote computing device;
determining, by the computer system, that the search query relates to a short-term attribute;
ranking, by the computer system, search results responsive to the search query in a manner that favors a user attribute classified as short-term over a user attribute classified as long term; and
transmitting, by the computer system to the remote computing device, the search results.

2. The computer-implemented method of claim 1, further comprising adding nodes and edges to a user attribute graph associated with the user, wherein the nodes represent the plurality of user attributes, and the edges represent relationships between the plurality of user attributes.

3. The computer-implemented method of claim 2, further comprising altering a confidence associated with one or more of the plurality of user attributes by storing, in association with a node representing the one or more of the plurality of user attributes, one or more confidence values.

4. The computer-implemented method of claim 1, further comprising inferring a first user attribute based on a second user attribute that was determined based on observed user activity, wherein the first user attribute is further inferred based on data that preexists the observed user activity.

5. The computer-implemented method of claim 4, wherein the preexisting data comprises aggregate user attributes of a population of users with which the user is associated.

6. The computer-implemented method of claim 4, wherein the preexisting data comprises an aggregate user attribute graph associated with a population of users with which the user is associated.

7. The computer-implemented method of claim 1, further comprising altering, by the computer system, a confidence associated with a first user attribute of the plurality of user attributes based on one or more additional activities by the user that corroborate the first user attribute.

8. The computer-implemented method of claim 7, further comprising altering, by the computer system, the confidence associated with a second user attribute of the plurality of user attributes that was inferred from the first user attribute based on the alteration of the confidence associated with the first user attribute.

9. The computer-implemented method of claim 7, further comprising classifying, by the computer system, the first user attribute as long-term in response to the confidence associated with the first user attribute satisfying a confidence threshold over a predetermined time interval.

10. (canceled)

11. The computer-implemented method of claim 1, further comprising reclassifying, by the computer system, a short-term user attribute as long term in response to a confidence associated with the short-term user attribute satisfying a confidence threshold over a predetermined time interval.

12. The computer-implemented method of claim 1, further comprising decaying, by the computer system, a confidence associated with a long-term user attribute between instances in which the long-term user attribute is corroborated.

13. The computer-implemented method of claim 12, further comprising declassifying the long-term user attribute in response to a determination that the confidence associated with the long-term user attribute no longer satisfies a threshold.

14. A system including memory and one or more processors operable to execute instructions stored in the memory, comprising instructions to:
determine, based on activity of a user, a plurality of user attributes associated with the user, wherein one or more of the plurality of user attributes are inferred from other user attributes of the plurality of user attributes;
classify one or more of the plurality of user attributes as short-term or long term based on corroboration of the respective user attribute over time;
receive, after the classifying, a search query submitted from the user using a remote computing device;
determine that the search query relates to a short-term attribute;
select one or more alternative query suggestions for presentation to the user in a manner that favors a user attribute classified as short-term over a user attribute classified as long term; and
transmit, to the remote computing device, the one or more alternative query suggestions.

15. The system of claim 14, wherein the memory further includes instructions to add nodes and edges to a user attribute graph associated with the user, wherein the nodes represent the plurality of user attributes, and the edges represent relationships between the plurality of user attributes.

16. The system of claim 15, wherein the memory further includes instructions to store, in association with a node representing the one or more user attributes, one or more confidence values.

17. The system of claim 14, wherein the memory further includes instructions to infer a first user attribute based on a second user attribute that was determined based on observed user activity, wherein the first user attribute is further inferred based on data that preexists the observed user activity.

18. The system of claim 17, wherein the preexisting data comprises aggregate user attributes of a population of users with which the user is associated.

19. The system of claim 17, wherein the preexisting data comprises an aggregate user attribute graph associated with a population of users with which the user is associated.

20. The system of claim 14, wherein the memory further comprises instructions to alter a confidence associated with a first user attribute based on one or more additional activities by the user that corroborate the first user attribute.

21. The system of claim 20, wherein the memory further comprises instructions to alter the confidence associated with a second user attribute hat was inferred from the first user attribute based on the alteration of the confidence associated with the first user attribute.

22. The system of claim 20, wherein the memory further comprises instructions to classify the first user attribute as long-term in response to satisfaction, by the confidence associated with the first user attribute, of a confidence threshold over a predetermined time interval.

23. (canceled)

24. The system of claim 14, wherein the memory further comprises instructions to classify a short-term user attribute as long term in response to a confidence associated with the short-term user attribute satisfying a confidence threshold over a predetermined time interval.

25. The system of claim 14, wherein the memory further comprises instructions to decay a confidence associated with a long-term user attribute between instances in which the long-term user attribute is corroborated.

26. The system of claim 25, wherein the memory further comprises instructions to declassify the long-term user attribute in response to a determination that the confidence associated with the long-term user attribute no longer satisfies a threshold.

27. At least one non-transitory computer-readable medium comprising instructions that, in response to execution of the instructions by a computer system, cause the computer system to perform the following operations:
determining, based on activity of a user, a plurality of user attributes associated with the user, wherein one or more of the plurality of user attributes are inferred from other user attributes of the plurality of user attributes;
classifying one or more of the plurality of user attributes as short-term or long term based on corroboration of the respective user attribute over time;
receiving, after the classifying, a search query submitted from a user using a remote computing device;
determining that the search query relates to a short-term attribute;
ranking search results responsive to the search query in a manner that favors a user attribute classified as short-term over a user attribute classified as long term; and
transmitting, to the remote computing device, the search results.
